(19) United States
(12) Patent Application Publication
(10) Pub. No.: US 2024/0067136 A1
(43) Pub. Date: Feb. 29, 2024

(54) SENSOR CLEANING APPARATUS, SENSOR, AND VEHICLE

(71) Applicant: Robert Bosch GmbH, Stuttgart (DE)

(72) Inventors: Mate Hornyak, Pakozd (HU); Akos Hegyi, Mezöhegyes (HU); Bence Balint, Monor (HU); Gyorgy Szabo, Budapest (HU); Janos Simonovics, Dunaharaszti (HU); Peter Deak, Budapest (HU); Zoltan Gyonyoru, Budapest (HU)

(21) Appl. No.: 18/454,208

(22) Filed: Aug. 23, 2023

(30) Foreign Application Priority Data
Aug. 24, 2022 (DE) 10 2022 208 760.7

(51) Int. Cl. B60S 1/56; B60S 1/04; B60S 1/34

(52) U.S. Cl. CPC B60S 1/566; B60S 1/043; B60S 1/3404

(57) ABSTRACT

A sensor cleaning apparatus, for cleaning a sensor field of a sensor, in particular a LiDAR sensor, of a vehicle, includes at least one wiper drive housing, which houses at least a majority of at least one wiper drive unit. At least one wiper is arranged at least partially outside of the wiper drive housing and is configured to clean the sensor field by way of a wiping motion. At least one wiper receiving element is provided for transferring a drive movement from the wiper drive unit to the wiper. The sensor cleaning apparatus further includes a sealing unit configured for an at least water-tight seal of the wiper drive housing and includes at least one movable passage opening for the wiper receiving element and/or for the wiper.

### BACKGROUND

Sensor cleaning apparatuses have previously been proposed for cleaning a LiDAR sensor of a vehicle, having at least one wiper drive housing, having at least one wiper arranged at least partially outside of the wiper drive housing, said wiper being configured to clean the sensor field by means of a wiping movement, and having at least one wiper receiving element for transferring a drive movement from the wiper drive unit to the wiper. Often, the known LiDAR sensors are arranged behind windscreens of vehicles that already have a windshield wiper for cleaning the windshield in the region of a driver's field of vision. LiDAR sensors located outside the windshield of the vehicle require their own sensor cleaning apparatuses specifically designed for the LiDAR sensor. In order to ensure functionality, the LiDAR sensor requires a constantly clean field of view, which is free of contamination by particles and by liquid droplets.

### SUMMARY

The invention relates to a sensor cleaning apparatus for cleaning a sensor field of a sensor, in particular a LiDAR sensor, of a vehicle, having at least one wiper drive housing, which houses at least a majority of at least one wiper drive unit, having at least one wiper arranged at least partially outside of the wiper drive housing and configured to clean the sensor field by way of a wiping motion, in particular exclusively translational, and having at least one wiper receiving element for transferring a drive movement from the wiper drive unit to the wiper.

It is proposed that the sensor cleaning apparatus comprise a sealing unit configured for an at least water-tight, in particular liquid-tight, preferably fluid-tight seal of the wiper drive housing and comprising at least one movable passage opening for the wiper receiving element and/or for the wiper. By means of the embodiment according to the invention, a high robustness and/or a high reliability of the wiper sensor cleaning systems, in particular of the wiper sensor cleaning systems with washing water spraying units, can advantageously be ensured. Advantageously, use of an advantageously compact, translationally moved wiper for cleaning sensor fields, in particular compared o a rotated wiper system, can be enabled. Advantageously, an in particular advantageously compact sensor cleaning apparatus can with a translationally moved wiper, which has a high sealability against liquid ingress, can be obtained.

The sensor, in particular the LiDAR (light detection and ranging) sensor, is configured to sense and/or detect at least a portion of an environment of the vehicle to which it is associated. Preferably, the sensor is designed as a driving assistance sensor for vehicles whose driving operation is at least partially assisted by driving assistance systems or for fully autonomously driving vehicles. In particular, the sensor senses the environment of the vehicle within a sensor field of view originating from the sensor. The sensor field of the sensor is in particular formed by a cross-section through the sensor field of view of the sensor, in particular in the region of a sensor cover or sensor housing of the sensor. The sensor housing can be designed separately or integrally with the wiper drive housing. Preferably, the sensor field is at least partially formed by the sensor housing of the sensor. The sensor field, in particular the surface of the sensor housing of the sensor in the region of the sensor field, can be designed to be planar or curved. However, the sensor field is preferably planar. In particular, the sensor field extends over less than 50% of a horizontal total circumference of the sensor housing. The terms “provided” and/or “configured” are in particular intended to mean specifically programmed, designed, and/or equipped. The concept that “an object is provided for a particular function” is in particular to be understood to mean that the object fulfills and/or performs this particular function in at least one application and/or operating state.

The vehicle can be designed as a land vehicle, for example a road vehicle or a rail vehicle, a marine vehicle, for example a ship or an amphibious vehicle, or an aircraft, for example an airplane, an airship, or a drone. The wiper drive unit comprises at least one electrical motor, which can be designed as a spindle drive, a rotational drive, or a linear drive. Preferably, the electric motor is designed as an electrically commutated DC motor that is particularly compact and/or is particularly low-wear. It is also conceivable that the wiper drive unit comprises a transmission interposed between an output of the electric motor and the wiper. A “majority” is to be understood to mean in particular 51%, preferably 66%, preferably 75%, advantageously 85%, and particularly preferably 95%. In particular, it is conceivable that the wiper drive housing will completely house the wiper drive unit. In particular, it is conceivable that the sensor housing will completely house the sensor. Alternatively, it is also conceivable that the sensor housing only forms the sensor cover, which covers the sensor field of view of the sensor outwardly. In particular, the sensor housing and/or the wiper drive housing is at least substantially water-tight, in particular liquid-tight, preferably liquid-tight. Preferably, the sensor housing is also dust-tight.

In particular, the wiper is designed in a manner similar to a window wiper for vehicle windows known from the prior art. In particular, the wiper comprises a wiper blade insert that wipes over the sensor field in order to clean the sensor field. In particular, the wiper is configured to clean the sensor field in a physical manner, in particular while contacting the sensor field or the sensor housing. Preferably, the wiper comprises at least one wiper blade, through which the wiper blade insert is in particular mounted. Preferably, the wiper comprises at least one wiping arm configured to produce a connection between the wiper blade and the wiper drive unit. In particular, the wiper receiving element forms the wiping arm. In particular, the wiper receiving element is designed as a wiper blade receiving element. In particular, the wiper receiving element is configured for mounting a wiper blade. However, alternatively, the wiper receiving element can also be designed differently from the wiping arm and/or the wiper can be designed without a separate component called a wiping arm. For example, the wiper blade can be integrally or monolithically designed with the wiper receiving element. The term “integral” is in particular understood to mean a bonded connection, e.g., by means of a welding process and/or an adhesive process, etc., and, in particular advantageously, integrally formed, e.g., by manufacture from a casting and/or by manufacture in a single component or multiple component injection molding process. In particular, the wiping arm receiving element is configured to follow the wiping movement, in particular translationally, and/or transfer the wiping movement, in particular translationally, from within the wiping drive housing to the wiper blade outside of the wiping drive housing. In particular, the drive movement corresponds approximately to the wiping movement.

In particular, the wiper blade is under a bias by means of which the wiper is pressed onto the sensor field or the sensor housing. Preferably, the wiper is provided for cleaning the sensor field at least to a large extent, preferably nearly completely. Preferably, when performing a wiping movement, the wiper passes completely or almost completely over a surface of the sensor housing that forms the sensor field of the sensor. The term “almost completely” is in particular understood to mean at least 90%, preferably at least 95%, and preferably at least 98%. If the sensor field or sensor housing has a curved surface, then the wiper follows the curvature during the wiping movement. Preferably, the translational wiping movement is achieved at least substantially by a horizontal or a vertical back-and-forth movement of the wiper (relative to a provided direction of placement of the associated vehicle). However, translational movements are also conceivable in planes that are different from a horizontal plane and a vertical plane. Preferably, the wiping movement is exclusively translational in opposite directions. Alternatively, it is also conceivable for the wiper to perform a pivoting movement, in particular in addition to the translational movement. It is also conceivable that the sensor cleaning apparatus comprises a washing water spraying unit configured to wet the sensor field for cleaning with washing water. The washing water spraying unit can be integrated into the wiper or can be designed separately from the wiper.

In particular, the sealing unit is configured at least for a water-tight, preferably at least liquid-tight, seal of the wiper drive housing outwards. With respect to the configuration of the sealing unit, the phrase “water-tight seal of the wiper drive housing” is in particular intended to mean that the wiper drive housing, at least in the region of the sealing unit, can withstand a water column (in mH₂O) of at least 500 mm, preferably at least 800 mm, advantageously at least 1,500 mm, preferably at least 3,000 mm, and more preferably at least 10,000 mm. In particular, the passage opening of the sealing unit surrounds the wiper receiving element at least on two opposite sides. In particular, the wiper receiving element is guided through the passage opening from an interior of the wiper drive housing to an exterior of the wiper drive housing. In particular, the passage opening is movable at least relative to the wiper drive housing and/or relative to the sensor, in particular operably movable. The passage opening passes entirely through the sealing unit. In the absence of the wiper receiving element, the passage opening forms a passage from the outside to the interior of the wiper drive housing. In particular, the sealing unit is also configured to provide a dust-tight seal of the wiper drive housing outwardly.

It is further proposed that the sealing unit comprises at least one movably mounted sealing element. As a result, a high sealability can advantageously also be achieved in the operation of the sensor cleaning apparatus, in particular in the wiping operation of the wiper. Advantageously, in particular in comparison to a pivoting wiper, a high compactness of the sensor cleaning apparatus and thus also the sensor can be achieved. Preferably, at least a portion of the sealing element is mounted so as to be translationally movable.

When the movable passage opening and/or the movably mounted sealing element is/are configured to follow the wiping movement, in particular a movement of the wiper blade of the wiper, during a wiping operation of the wiper, a high sealability can advantageously also be achieved in the operation of the sensor cleaning apparatus, in particular in the wiping operation of the wiper. Advantageously, in particular in comparison to a pivoting wiper, a high compactness of the sensor cleaning apparatus and thus also the sensor can be achieved. It is conceivable that the wiper, in particular the wiper receiving element, will generate the movement of the passage opening and/or the sealing element, for example by pushing on and/or pulling along the passage opening and/or the sealing element during the movement of the wiper receiving element or the wiper. Alternatively, however, it is also conceivable that the passage opening and/or the sealing element are at least partially self-driven, e.g. by the wiper drive unit or by a further separate drive unit.

In addition, it is proposed that the wiper receiving element and/or the wiper, in particular at least in the region of the passage opening, is at least water-tightly, preferably at least fluid-tightly, connected to the sealing unit, in particular to the sealing element. As a result, a high sealability can advantageously also be achieved in the operation of the sensor cleaning apparatus, in particular in the wiping operation of the wiper. For example, the sealing element can be fixedly and water-tightly pressed against the wiper receiving element. For example, the sealing element can be connected to the wiper receiving element, e.g., attached, glued, or the like. In particular, the wiper receiving element is at least dust-tightly connected to the sealing unit, in particular to the sealing element.

It is further proposed that the sealing unit, in particular the sealing element, is designed as a flexible tape. A high sealability can thus advantageously be achieved. Advantageously, a particularly simple and/or inexpensive design can be achieved. In particular, the flexible tape is designed as a ribbon. In particular, the flexible tape is designed as an annularly closed tape, in particular with the exception of the passage opening. The passage opening can be circumferentially limited by the flexible tape or can completely intersect the flexible tape. In the event that the flexible tape is completely intersected by the passage opening, a material connection of the wiper receiving element to the flexible tape may be required. Preferably, however, the passage opening forms a hole in the flexible tape that is limited by the flexible tape all the way around in the circumferential direction of the passage opening. This can advantageously ensure a good seal of the wiper receiving element in all directions. In particular, the passage opening passes through the flexible tape designed as a ribbon between two flat sides. In particular, the flexible tape is designed similarly to a known household rubber tape. In particular, a planar side of the flexible tape designed as a ribbon is aligned at least substantially perpendicular to a wiping plane of the wiper and/or to the sensor field. The term “substantially perpendicular” is in this context understood in particular to mean an orientation of a direction relative to a reference direction, whereby the direction and the reference direction, in particular as viewed in a projection plane, enclose an angle of 90°, and the angle has a deviation of in particular less than 8°, advantageously less than 5°, and in particular advantageously less than 2°. In particular, the flexible tape is monolithic, preferably made from a single material. In particular, the flexible tape is made from a material having low or marginal liquid absorption. In particular, the flexible strip is made from a material with a high chemical resistance, in particular against surfactants or alcohols. In particular, the flexible tape is made from a material having a low surface friction. In particular, the flexible tape is made from a material having a high heat resistance. In particular, the flexible tape is made from a material having a low flammability. In particular, the flexible tape is made from a material with particularly good aging and/or wear properties. Advantageously, the flexible tape is made from an ethylene-propylene-diene (monomer) rubber. Alternatively, the flexible tape can be made from an ethylene polymer, from a silicone, or from a polyethylene. Of course, various configurations of the flexible tape that deviate in particular from the ribbon shape are also conceivable for the above-described configurations of the flexible tape. In particular, the flexible tape adjoins one side of the sensor field. In particular, a length of the flexible tape is at least two times a horizontal extension of the sensor field and/or a vertical extension of the sensor field. In particular, a length of the flexible tape is at least two times a maximum travel path of the wiper receiving element and/or the passage opening in a consistent direction. In particular, the flexible tape runs on an at least substantially oval web. In particular, the flexible tape is mounted in a strained state or under tensile stress.

It is further proposed that the sealing unit comprises a faceplate that seals the sealing element towards a front side, in particular of the sensor cleaning apparatus, preferably of the sensor housing. As a result, a high sealability can advantageously be ensured, in particular also in the driving operation of the vehicle. In addition, a high sealability of the design can advantageously be ensured with the flexible tape. The front side is in particular the side at which the sensor field of view exits the sensor housing. Preferably, the faceplate is aligned at least substantially parallel with the sensor field. Preferably, the faceplate is arranged above or to the side of the sensor field, in particular in the positioning direction of the vehicle. In particular, the faceplate contacts the flexible tape designed as a ribbon on a side surface arranged perpendicular to the flat side of the ribbon.

In particular, as an alternative to the flexible tape, it is proposed that the sealing unit comprises a chain-like seal support element, which supports at least one flexible sealing element extending over a plurality of chain links of the seal support element. A particularly reliable design of the sealing unit can thus advantageously be achieved, which is preferably particularly insensitive to aging effects of flexible materials. In particular, the sealing element is, e.g., connected to the chain links of the plurality of chain links in a bonded and/or interlocking manner. The term “interlocking connection” is in particular understood to mean that the mass parts are held together by atomic or molecular forces, e.g., through soldering, welding, gluing, and/or vulcanizing. The term “interlocking” is in particular understood to mean that contiguous faces of components connected to one another in an interlocking manner exert a holding force on one another that acts in the normal direction of the faces. In particular, the components are in geometrical engagement with one another. In particular, the seal support element supports a respective flexible sealing element on opposite sides. In particular, the seal support element comprises a short side and a flat side. In particular, the seal support element supports the flexible sealing element on a short side. In particular, a flat side of the seal support element has no sealing elements.

In addition, if the seal support element is made from chain links that are at least water-tightly, preferably at least fluid-tightly, and in particular at least dust-tightly connected to one another, in particular clipped to one another, and can at least be rotated relative to one another, then a high degree of dimensional stability can be advantageously achieved while at the same time providing a strong sealing effect and ductility. Advantageously, a simple length adjustment to various types of the sensor cleaning apparatuses can be enabled. In particular, the chain links are rotatable at least about an axis that is at least substantially parallel to a flat side of the seal support element. The term “substantially parallel” is in particular intended here to be understood to mean an orientation of a direction relative to a reference direction, in particular in a plane, wherein the direction has a deviation from the reference direction of in particular less than 8°, advantageously less than 5°, and in particular advantageously less than 2°. The phrase “the seal support elements are connected to one another in a water-tight manner” is in particular understood to mean that at least the connection of the seal support elements can withstand a water column (in mH₂O) of at least 500 mm, preferably at least 800 mm, advantageously at least 1,500 mm, preferably at least 3,000 mm, and more preferably at least 10,000 mm. Advantageously, the chain links can be connected to one another without tools. In particular, the chain links of the seal support element are designed and/or connected to one another in the manner of a “tambour door”.

In addition, if the seal support element is designed as an endless chain, then a particularly strong sealability can advantageously be achieved. If the seal support element is designed as an open chain instead, then a use of material and/or cost can advantageously be minimized. In particular, the sealing element arranged on the seal support element is endless or open, as is the associated seal support element. In particular, in the case of the open chain, additional seals can become necessary at the reversal points of the wiper.

In particular, the wiper receiving element, which is in particular passed through the chain-like seal support element, can be connected to the adjacent chain links in the same way as the interconnected chain links. To this end, on opposite sides, the wiper receiving element comprises clip elements (interlocking elements), by means of which the wiper receiving element can be clipped into the adjacent chain links. In particular, the sealing element is designed to not be interrupted in the region of the passage opening by the chain-like seal support element. In particular, in the region of the passage opening through the chain-like seal support element, the sealing element seals the wiper receiving element guided through the passage opening. The sealing element connected to the seal support elements can be made from the same material or from a material having the same properties described hereinabove as the aforementioned sealing element designed as a flexible tape. Alternatively, the sealing element connected to the seal support elements can be designed as small brushes or bristles, or as a foam (material) seal. In addition, the sealing element could also be made from aluminum, e.g. guided in a dense rail, or from various rubberized materials. The chain links of the seal support element can be made from a plastic or from a metal, e.g. aluminum.

Additionally, it is proposed that the sealing element comprises at least one guide element for guiding the movement of the sealing element, which is configured to engage with a corresponding guide element of the wiper drive housing. A particularly high sealability can thus advantageously be achieved, in particular also in an operation of the wiper. Advantageously, a sealing unit comprising in particular the chain links can be used in order to prevent malfunction, for example a popping out of the sealing unit from an intended construction space. For example, the corresponding guide element of the wiper drive housing can be designed as a groove into which the sealing element, in particular the guide element of the sealing element, engages in an interlocking manner. The reverse design is of course also conceivable.

Furthermore, the sensor, in particular the LiDAR sensor, with the sensor field and with the sensor cleaning apparatus, as well as the vehicle, in particular an air, water, and/or land vehicle, with the sensor are proposed. Through the embodiment according to the invention, a high robustness and/or a high reliability of the sensor systems of vehicles can advantageously be ensured. The vehicle can in particular be designed as a self-driving vehicle or as a driver-controlled vehicle with driving assistance systems.

The sensor cleaning apparatus according to the invention, the sensor according to the invention, and/or the method according to the invention here is/are not intended to be limited to the application and embodiment described above. In particular, for fulfilling a functionality described herein, the sensor cleaning apparatus according to the invention, the sensor according to the invention, and/or the method according to the invention can comprise a number of individual elements, components, units, and method steps that deviates from a number specified herein. Moreover, regarding the ranges of values indicated in this disclosure, values lying within the specified limits are also intended to be considered as being disclosed and usable in any desired manner.

### BRIEF DESCRIPTION OF THE DRAWINGS

Further advantages follow from the description of the drawings hereinafter. The drawings illustrate two exemplary embodiments of the invention. The drawings, the description, and the claims contain numerous features in combination. The skilled person will appropriately also consider the features individually and combine them into additional advantageous combinations.

Shown are:

FIG. 1. a schematic illustration of a vehicle having a sensor and a sensor cleaning apparatus,

FIG. 2 a schematic perspective illustration of the sensor with the sensor cleaning apparatus,

FIG. 3 a schematic side view of the sensor with the sensor cleaning apparatus,

FIG. 4 a further schematic perspective illustration of the sensor with the sensor cleaning apparatus,

FIG. 5 a second further schematic perspective illustration of the sensor with the sensor cleaning apparatus,

FIG. 6 a schematic perspective illustration of a portion of an alternative sensor cleaning apparatus having an alternative sealing unit; and

FIG. 7 a schematic perspective illustration of a portion of the alternative sealing unit.

### DETAILED DESCRIPTION

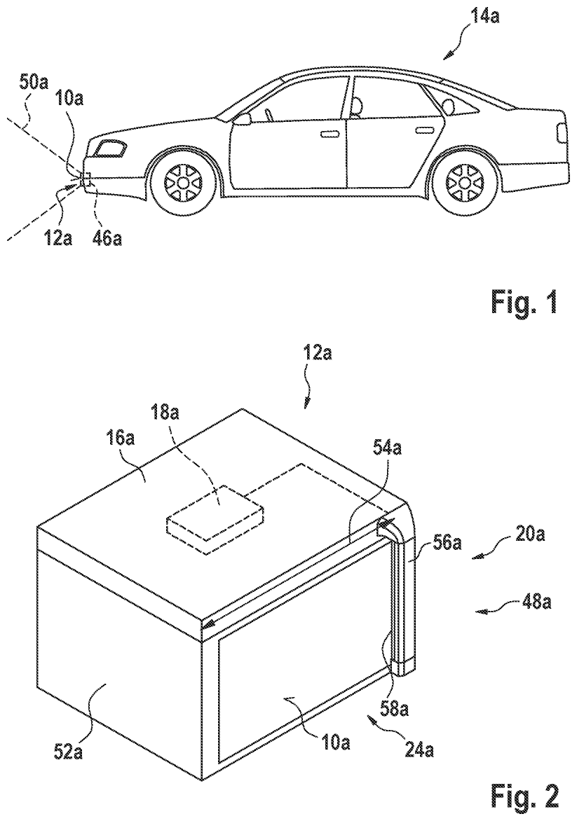

FIG. 1 schematically shows a vehicle 14a. The vehicle 14a is, e.g., designed as a passenger car. The vehicle 14a comprises a sensor 12a. The sensor 12a is designed as a driving assistance sensor. The sensor 12a is designed as a LiDAR sensor. The sensor 12a comprises a sensor field of view 50a. The sensor 12a is at least configured to detect objects within the sensor field of view 50a. The sensor 12a forms a sensor field 10a. The sensor field 10a is formed by a surface region of the sensor 12a out of which the sensor field of view 50a exits. The sensor 12a comprises a sensor cleaning apparatus 48a (see FIG. 2, etc.). The sensor cleaning apparatus 48a is provided for cleaning sensor field 10a of the sensor 12a.

FIG. 2 shows a schematic perspective view of the sensor 12a with the sensor cleaning apparatus 48a. The sensor 12a comprises a sensor housing 52a. The sensor housing 52a forms the sensor field 10a. The sensor field 10a is arranged on a front face 34a of the sensor 12a, in particular of the sensor housing 52a. The sensor field 10a covers a majority of the front face 34a of the sensor 12a. The sensor field 10a is shown as a planar surface. Alternatively, the sensor field 10a could also have a curvature, e.g. in the horizontal direction 54a.

The sensor cleaning apparatus 48a comprises a wiper 20a. The wiper 20a is configured to clean the sensor field 10a by means of a wiping movement. The wiper 20a extends perpendicular to the horizontal direction 54a. The wiping movement of the wiper 20a is exclusively translational. The wiping movement of the wiper 20a runs exclusively along the planar surface of the sensor field 10a. The wiping movement of the wiper 20a runs back and forth in an alternating fashion. The wiping movement of the wiper 20a runs along the horizontal direction 54a. Alternatively, the wiping movement of the wiper 20a could also run perpendicular to the horizontal direction 54a and/or the wiper 20a could extend parallel to the horizontal direction 54a. The horizontal direction 54a runs perpendicular to a gravitational direction when the vehicle 14a is positioned in a normal standing state on a planar surface. The wiper 20a comprises a wiper drive unit 18a. The wiper drive unit 18a comprises an electrical motor. The wiper drive unit 18a is provided in order to generate the driving force for the wiping movement, in particular a driving movement.

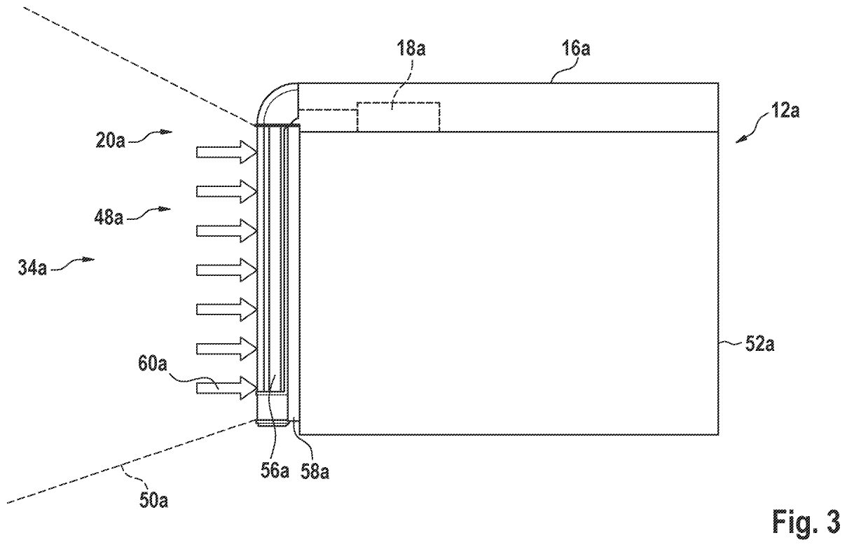

The sensor cleaning apparatus 48a comprises a wiper drive housing 16a. The wiper drive housing 16a houses the wiper drive unit 18a. The wiper drive housing 16a is fixed to the sensor housing 52a. The wiper drive housing 16a could also be partially integrally designed with sensor housing 52a. The wiper drive housing 16a is mounted on top of the sensor housing 52a, in particular when viewed in the installation direction. Alternatively, the wiper drive housing 16a could also be mounted below or to the side of the sensor housing 52a. The wiper 20a is arranged at least partially outside of the wiper drive housing 16a. The wiper 20a comprises a wiper blade 56a. A majority of the wiper blade 56a is arranged outside of the wiper drive housing 16a. The wiper 20a comprises a wiper blade insert 58a. The wiper blade insert 58a is arranged outside of the wiper drive housing 16a. The wiper blade insert 58a contacts the sensor field 10a. The wiper blade insert 58a wipes over the sensor field 10a in order to clean the sensor field 10a. The wiper blade 56a is pressed onto the sensor field 10a while biased by means of a compressive force 60a (see FIG. 3).

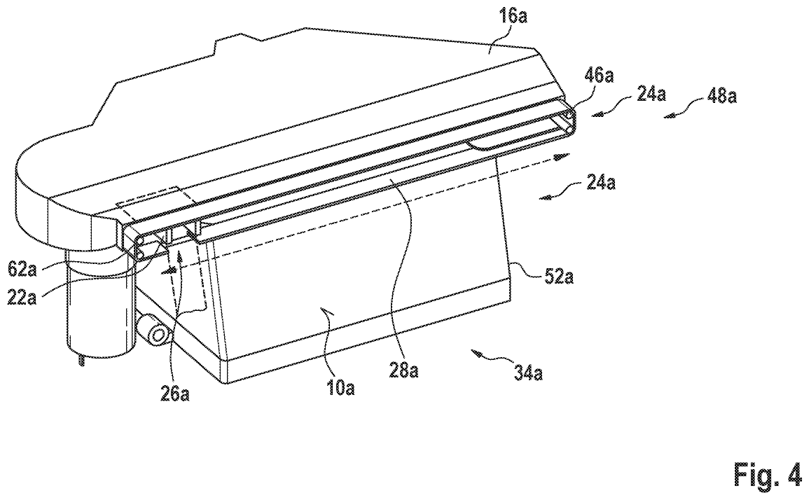

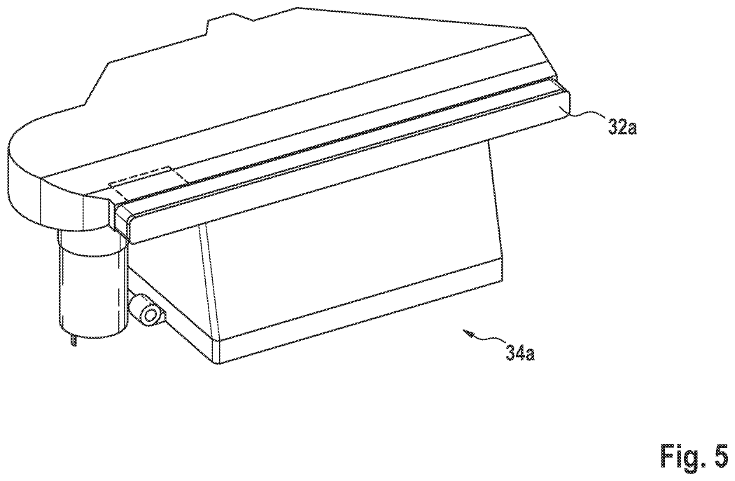

FIG. 4 schematically illustrates a perspective view of a portion of the sensor cleaning apparatus 48a. The sensor cleaning apparatus 48a comprises a wiper receiving element 22a. The wiper receiving element 22a is configured to transfer the drive movement from the wiper drive unit 18a to the wiper 20a. The wiper receiving element 22a is configured to transfer the drive movement from the wiper drive unit 18a to the wiper blade 56a. The wiper receiving element 22a is guided out of the wiper drive housing 16a. The wiper receiving element 22a is partially arranged within the wiper drive housing 16a. The wiper receiving element 22a is partially arranged outside of the wiper drive housing 16a.

The sensor cleaning apparatus 48a comprises a sealing unit 24a. The sealing unit 24a is configured to provide a water-tight seal of the wiper drive housing 16a. The sealing unit 24a is configured to provide a dust-tight seal of the wiper drive housing 16a. The sealing unit 24a comprises a sealing element 28a. The sealing element 28a is designed as a flexible tape. The sealing unit 24a comprises a passage opening 26a. The sealing element 28a comprises the passage opening 26a. The passage opening 26a passes entirely through the sealing element 28a. The passage opening 26a is circumscribed, or rather bordered circumferentially, by the sealing element 28a. The passage opening 26a forms a connection from an interior of the wiper drive housing 16a outwards. The passage opening 26a is provided in order to receive a portion of the wiper 20a. The passage opening 26a is provided in order to receive a portion of the wiper blade 56a (merely hinted at in FIG. 4). The passage opening 26a can also be provided in order to receive the wiper receiving element 22a.

The portion of the wiper 20a received in the passage opening 26a completely fills the passage opening 26a. The wiper 20a (or the wiper receiving element 22a, depending on which component passes through the passage opening 26a) is connected to the sealing unit 24a in a water-tight manner. The wiper 20a (or the wiper receiving element 22a, depending on which component passes through the passage opening 26a) is dust-tightly connected to the sealing unit 24a. The passage opening 26a is movable. The sealing unit 24a is movable. The sealing element 28a is movable. The sealing element 28a of the sealing unit 24a is movably mounted. The movable passage opening 26a is configured to follow the wiping movement during a wiping operation of the wiper 20a. The sealing element 28a is configured to follow the wiping movement during the wiping operation of the wiper 20a.

The sealing element 28a designed as a flexible tape in FIG. 4 is designed as a ribbon. The sealing element 28a designed as a flexible tape is mounted with tension. The sensor cleaning apparatus 48a comprises deflection rollers 46a, 62a. The deflection rollers 46a, 62a are mounted at opposite ends of the wiper drive housing 16a. The deflection rollers 46a, 62a are arranged on opposite sides of the sensor field 10a. The deflection roller rollers 46a, 62a are arranged in the region of the reversal points of the wiping movement of the wiper 20a. The sealing element 28a designed as a flexible tape is guided around the deflection rollers 46a, 62a. The sealing element 28a designed as a flexible tape is clamped between the deflection rollers 46a, 62a. The sealing element 28a designed as a flexible tape passes around the deflection rollers 46a, 62a during the movement of the passage opening 26a and/or the wiper 20a. The wiper drive unit 18a pushes the sealing element 28a designed as a flexible tape around the deflection rollers 46a, 62a due to the movement of the wiper 20a. Instead of deflection rollers, alternative deflection elements are also conceivable, e.g. deflection blocks.

FIG. 5 shows the same schematic perspective view onto the portion of the sensor cleaning apparatus 48a as in FIG. 4. The sealing unit 24a comprises a faceplate 32a. The faceplate 32a seals the sealing element 28a toward the front side 34a. The faceplate 32a is fixed to the wiper drive housing 16a by means of a pressure acting in the direction of the wiper drive housing 16a.

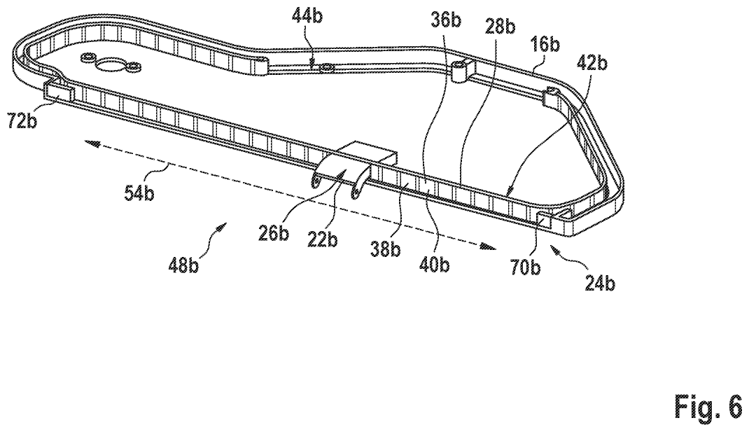

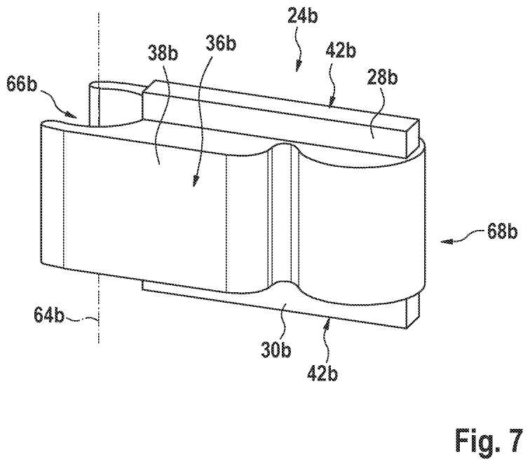

FIGS. 6 and 7 show a further exemplary embodiment of the invention. The following descriptions and the drawings are essentially limited to the differences between the exemplary embodiments, whereby, with respect to identically designated components, in particular with respect to components having the same reference characters, reference can in principle also be made to the drawings and/or the description of the other exemplary embodiments, in particular FIGS. 1 to 5. In order to distinguish between the exemplary embodiments, the letter a is appended to the reference characters for the exemplary embodiment in FIGS. 1 to 5. In the exemplary embodiments of FIGS. 6 and 7, the letter a is replaced by the letter b.

FIG. 6 schematically illustrates a perspective view of a portion of an alternative sensor cleaning apparatus 48b. The alternative sensor cleaning apparatus 48b comprises a wiper drive housing 16b that houses a wiper drive unit 18b. The alternative sensor cleaning apparatus 48b comprises a wiper receiving element 22b. The wiper receiving element 22b is configured to retain a wiper 20b of the alternative sensor cleaning apparatus 48b. The wiper receiving element 22b is guided out of the wiper drive housing 16b. The wiper receiving element 22b is partially arranged within the wiper drive housing 16b. The wiper receiving element 22b is partially arranged outside of the wiper drive housing 16b. The alternative sensor cleaning apparatus 48b comprises an alternative sealing unit 24b. The alternative sealing unit 24b is configured to provide a water-tight seal of the wiper drive housing 16b. The alternative sealing unit 24b is configured to provide a dust-tight seal of the wiper drive housing 16b. The alternative sealing unit 24b comprises a passage opening 26b.

The alternative sealing unit 24b comprises a seal support element 36b. The seal support element 36b is designed in a chain-like fashion. The seal support element 36b comprises a plurality of chain links 38b, 40b. The seal support element 36b is designed to resemble a “tambour door”. The chain links 38b, 40b of the seal support element 36b are rotatable with respect to one another. The chain links 38b, 40b of the seal support element 36b are rotatable with respect to one another about an axis of rotation 64b (see FIG. 7), which extends perpendicular to a horizontal direction 54b and/or parallel to a longitudinal extension of the wiper 20b. The chain links 38b, 40b of the seal support element 36b are connected to one another. The chain links 38b, 40b of the seal support element 36b are connected to one another in a water-tight manner. The chain links 38b, 40b of the seal support element 36b are connected to one another in a dust-tight manner. Each chain link 38b, 40b of the seal support element 36b (with the exception of the edge links in a non-endless design) is connected to each of two adjacent chain links 38b, 40b of the seal support element 36b. The chain links 38b, 40b of the seal support element 36b are connected to one another by clips. Each of the chain links 38b, 40b comprises two interlocking elements 66b, 68b corresponding to one another (see FIG. 7), which can be inserted into one another using the interlocking elements 66b, 68b of the adjacent, in particular identically designed, chain links 38b, 40b. The chain links 38b, 40b are identical to one another (with the exception of the edge links in a non-endless design). The wiper receiving element 22b also comprises interlocking elements (not shown) that can be clipped into the respective chain links 38b, 40b of the seal support element 36b circumscribing the passage opening 26b.

The seal support element 36b comprises the passage opening 26b. The passage opening 26b passes entirely through the seal support element 36b. The passage opening 26b interrupts the chain of the seal support element 36b. The passage opening 26b is circumscribed or bordered on two sides by the seal support element 36b. The sealing unit 24b comprises a first flexible sealing element 28b. The sealing unit 24b comprises a second flexible sealing element 30b (see FIG. 7). The first sealing element 28b extends over a plurality of chain links 38b, 40b of the seal support element 36b. The second sealing element 30b extends over a plurality of chain links 38b, 40b of the seal support element 36b. The first sealing element 28b extends over all of the chain links 38b, 40b of the seal support element 36b. The second sealing element 30b extends over all of the chain links 38b, 40b of the seal support element 36b. The first sealing element 28b extends over the wiper receiving element 22b. The second sealing element 30b extends over the wiper receiving element 22b. The passage opening 26b is circumscribed on one side by the first sealing element 28b. The passage opening 26b is circumscribed on one side by the second sealing element 30b.

The sealing elements 28b, 30b each comprise a respective guide element 42b for guiding the movement of the sealing elements 28b, 30b. The alternative sensor cleaning apparatus 48b comprises a corresponding guide element 44b. The corresponding guide element 44b is integrated into the wiper drive housing 16b. The corresponding guide element 44b is designed as a guide rail integrated into the wiper drive housing 16b. The guide element 42b is configured for an engagement with the corresponding guide element 44b of the wiper drive housing 16b. The corresponding guide element 44b can be designed circumferentially around the entire wiper drive housing 16b or can extend only over a portion of a circumference of the wiper drive housing 16b. In the case illustrated in FIG. 6, the seal support element 36b is designed as an open chain. A design of the seal support element 36b as an endless chain is also conceivable, but no pictorial representation is provided herein. In this case, the sealing elements 28b, 30b would then be designed as contiguous, integral rings. The alternative sealing unit 24b comprises lateral sealing elements 70b, 72b. The lateral sealing elements 70b, 72b are configured to seal the lateral ends of the open chain of the seal support element 36b such that no dust and/or liquid can penetrate into the interior of the wiper drive housing 16b. In a design of the seal support element 36b as an endless chain, the lateral sealing elements 70b, 72b could also be omitted.

1. A sensor cleaning apparatus (48a-b) for cleaning a sensor field (10a-b) of a sensor (12a-b), said apparatus comprising at least one wiper drive housing (16a-b), which houses at least a majority of at least one wiper drive unit (18a-b), comprising at least one wiper (20a-b) arranged at least partially outside of the wiper drive housing (16a-b) and configured to clean the sensor field (10a-b) by way of a wiping motion, and comprising at least one wiper receiving element (22a-b) for transferring a drive movement from the wiper drive unit (18a-b) to the wiper (20a-b), and further comprising a sealing unit (24a-b) configured for an at least water-tight seal of the wiper drive housing (16a-b) and comprising at least one movable passage opening (26a-b) for the wiper receiving element (22a-b) and/or for the wiper (20a).

2. The sensor cleaning apparatus (48a-b) according to claim 1, wherein the sealing unit (24a-b) comprises at least one movably mounted sealing element (28a-b, 30b).

3. The sensor cleaning apparatus (48a-b) according to claim 2, wherein the movable passage opening (26a-b) and/or the movably mounted sealing element (28a-b, 30b) is/are configured to follow the wiping movement during a wiping operation of the wiper (20a-b).

4. The sensor cleaning apparatus (48a-b) according to claim 1, wherein the wiper receiving element (22a-b) and/or the wiper (20a-b) is/are at least connected to the sealing unit (24a-b) in a water-tight manner.

5. The sensor cleaning apparatus (48a) according to claim 2, wherein the sealing element (28a) is configured as a flexible tape.

6. The sensor cleaning apparatus (48a) according to claim 1, wherein the sealing unit (24a) comprises a faceplate (32a), which seals the sealing element (28a) towards a front side (34a).

7. The sensor cleaning apparatus (48b) according to claim 1, wherein the sealing unit (24b) comprises a chain-like seal support element (36b), which supports at least one flexible sealing element (28b, 30b) extending over a plurality of chain links (38b, 40b) of the seal support element (36b).

8. The sensor cleaning apparatus (48b) according to claim 7, wherein the seal support element (36b) includes chain links (38b, 40b) that are at least connected to one another in a water-tight manner, and are at least rotatable relative to one another.

9. A sensor cleaning apparatus (48b) according to claim 7, wherein the seal support element (36b) is configured as an endless chain or an open chain.

10. The sensor cleaning apparatus (48a-b) according to claim 2, wherein the sealing element (28a-b, 30b) comprises at least one guide element (42a-b) for guiding the movement of the sealing element (28a-b, 30b), which is configured for an engagement with a corresponding guide element (44a-b) of the wiper drive housing (16a-b).

11. A sensor (12a-b) having a sensor field (10a-b) and having the sensor cleaning apparatus (48a-b) according to claim 1 for cleaning the sensor field (10a-b).

12. A vehicle (14a-b) having a sensor (12a-b) according to claim 11.

13. The sensor cleaning apparatus (48a-b) of claim 1, wherein the sensor is a LiDAR sensor in a vehicle (14a-b).

14. The sensor cleaning apparatus (48a-b) of claim 1, wherein the wiping motion of the wiper (20a-b) is exclusively translational.

15. The sensor cleaning apparatus (48a-b) of claim 8, wherein the chain links (38b, 40b) are clipped onto one another.

16. The sensor cleaning apparatus (48a-b) according to claim 7, wherein the sealing element (28a-b, 30b) comprises at least one guide element (42a-b) for guiding the movement of the sealing element (28a-b, 30b), which is configured for an engagement with a corresponding guide element (44a-b) of the wiper drive housing (16a-b).

17. The sensor (12a-b) according to claim 11, wherein the sensor is a LiDAR sensor.

18. The vehicle (14a-b) according to claim 12, where the vehicle is an air, water, and/or land vehicle.
